(19) United States
(12) Patent Application Publication
(10) Pub. No.: US 2016/0163122 A1
(43) Pub. Date: Jun. 9, 2016

(54) SYSTEM AND METHOD FOR MANAGING A PARKING PROCESS OF A VEHICLE IN A PARKING ZONE WHICH IS SUBJECT TO CHARGES, AND FOR MANAGING A COUNTING PROCESS FOR PAYING PARKING CHARGES

(71) Applicant: SUNHILL TECHNOLOGIES GMBH, Erlangen (DE)

(72) Inventors: Matthias MANDELKOW, Bubenreuth (DE); Christoph SCHWARZMICHEL, Hoechstadt (DE)

(73) Assignee: Sunhill Technologies GMBH

(21) Appl. No.: 14/908,591

(22) PCT Filed: Jul. 31, 2014
(86) PCT No.: PCT/EP2014/002105

§ 371 Date: Jan. 29, 2016

(30) Foreign Application Priority Data
Aug. 1, 2013 (EP) 13179011.5

(51) Int. Cl. G07B 15/04; G07B 1/00; G06Q 20/32; G06Q 50/30

(52) U.S. Cl. CPC G07B 15/04; G06Q 50/30; G07B 1/00; G06Q 20/3255; G06Q 20/3278

(57) ABSTRACT

A system is disclosed for managing a parking process of a vehicle in a parking zone which is subject to charges. The system includes a controller; a first device for identifying the user and/or the vehicle; a second device for identifying the entry process; a device for implementing the identification and embodied to detect the identification of the entry process for triggering and/or carrying out a counting process; and a communication device to transmit and generate an exit permission signal, in response to the transfer of the identification signals from a user to the control device. The controller is embodied to trigger the counting process and/or carry it out as soon as the parking zone is exited. A method is also disclosed.

### PRIORITY STATEMENT

This application is the national phase under 35 U.S.C. §371 of PCT International Application No. PCT/EP2014/002105 which has an International filing date of Jul. 31, 2014, which designated the United States of America and which claims priority to European patent application number EP13179011.5 filed Aug. 1, 2013, the entire contents of which are hereby incorporated herein by reference.

### FIELD

A system and method are generally disclosed for managing a parking process of a vehicle in a parking zone which is subject to charges and for managing a payment process for paying parking fees or charges.

An embodiment of the present invention generally relates to a system for managing a parking process of a vehicle in a parking zone which is subject to charges and for managing a payment process for paying parking fees. An embodiment of the invention furthermore generally relates to a corresponding method for operating the inventive system.

Managing of the parking process in this case is understood to refer to parking subject to charges in private or public parking spaces and/or in parking garages, including the automated payment. Automated payment is understood to refer to determining the parking fee, following a specific parking period, debiting of the determined parking fee from an account of the vehicle user, and releasing the vehicle once the account has been debited.

### BACKGROUND

Methods and systems are known from the prior art which allow a predesignated parking in individual, localizable parking spaces in free parking zones, using different approaches. Wireless signal transmission and, in particular, mobile radio generally are used for this.

A parking system subject to charges or fees is known specifically from the WO 96/27170 A (Parkit Oy) and is provided with a control unit with parking-fee register that allows assigning the parking space to a user's vehicle and to determine the fee for the parking period on the basis of stored data for parking fees and the associated parking period information, which fee is then debited from a user account.

A parking fee system is furthermore proposed in the WO 01/88 855 A (=EP 1 312 049 B1 (Payway Oy)) for which a central unit for parking fees is activated via a parking ticket device and is connected to the user via mobile radio network. When leaving the parking zone, an exit control device is activated via the parking fee central unit with the aid of a ticket-specific exit permission code.

The WO 01/88 856 A (=EP 1312 050 B1 (Payway Oy)), on the other hand, proposes defining individual parking spaces for the parking process and storing the parking space information additionally in the register of the central parking fee unit for determining the correct parking fee.

The unique feature of the aforementioned systems is that the payment function—corresponding to the older prior art—is realized prior to leaving the parking zone. To be sure, it is already realized therein via cell phone and mobile radio systems, but always requires a separate check-in and check-out process. During the check-out, the permission to exit is valid only for a specific time interval during which the exit gate opens up. If the time interval is exceeded, the complete check-out process must be repeated. In practice this results in an undesirable time expenditure for the user and the operator and is problematic, especially if the time interval expires just before the attempt to exit since it frequently causes an undesirable jam in the parking zone, causing high annoyance for the user.

### SUMMARY

At least one embodiment of the present invention to provide an improved system and/or associated method for operating the system which simplifies the managing of the parking process and the associated process for paying the parking fees, but in an appropriate manner.

At least one embodiment of the present invention provides an improved system. A sequence of method steps is carried out in at least one embodiment to realize at least one embodiment of the system.

In at least one embodiment of the invention, technical devices are provided which communicate with a control device. On the one hand, user-specific information for specific marginal conditions of the parking process is thus transmitted in the form of identification signals to the control unit where this information is processed and is then returned via a communication network for releasing the exit. On the other hand, the parking fees are debited from the user account only after exiting the parking zone. The above-described problem situations are thus solved because the actual payment process takes place only after exiting through the gate system. The user can thus always exit and the operator is accorded the actual fee for the total parking period inside the object. The system is fully supported by mobile radio—in particular also by SMS—wherein other transmission methods such as bluetooth can also be used.

On the whole, this results in a considerable improvement of the aforementioned system.

For the realization of at least one embodiment of the invention using a gate for the parking zone, the gate is not—as with the above-described prior art—opened during the time interval in response to an exit permission code which confirms the payment of the parking fee. Rather, the parking fee is determined precisely during the exit and is debited/or paid only after exiting the parking zone. For the operator of the parking facility this ensures a better accounting option for the correct parking period, and for the consumer (user) it ensures actual independence from specified time intervals during the exit from the parking zone following the check-out.

For the realization of at least one embodiment of the invention using a gate for the parking zone, the gate is not—as with the above-described prior art—opened during the time interval in response to an exit permission code which confirms the payment of the parking fee. Rather, the parking fee is determined precisely during the exit and is debited/or paid only after exiting the parking zone. For the operator of the parking facility this ensures a better accounting option for the correct parking period, and for the consumer (user) it ensures actual independence from specified time intervals during the exit from the parking zone following the check-out.1

In one specific aspect, at least one embodiment of the invention therefore relates to a system for managing a parking process of a vehicle in a parking zone subject to charge and a payment process for paying parking fees, comprising:
a control unit for controlling the parking process and the payment process, wherein the control unit communicates with a communication network;
a device for generating and issuing a parking ticket which communicates with the control unit, wherein the device for generating and issuing a parking ticket is embodied such that it generates an identifier on the parking ticket;
an entry blocking device, which is embodied so as to communicate with the control unit and/or the device for generating and issuing a parking ticket, such that it opens up or can open up once a parking ticket is issued;
a device for accepting a parking ticket which communicates with the control unit, wherein the device for accepting a parking ticket is designed to detect the identifier on the parking ticket in order to trigger and/or realize a payment process;
an exit blocking device, embodied so as to communicate with the control unit and/or the device for accepting a parking ticket, such that it opens up or can open up upon detecting the identifier,
   the control unit is embodied to receive the identifier via the communication network;
   the control unit is embodied to generate an exit permission signal in response to a user transmitting the identifier on the parking ticket to the control unit; and
   the control unit is embodied such that it triggers and/or realizes the payment process as soon as the exit blocking device is activated or was activated.

According to a different aspect, at least one embodiment of the invention relates to the associated method for managing a vehicle parking process in a parking zone subject to charges and a payment process for paying the parking fees, with a control unit for controlling the parking process and the payment process, wherein the control unit is connected to a communication network, wherein the method comprises the following steps:
generating and issuing a parking ticket upon request from the user, with the aid of a device for issuing parking tickets which communicates with the control unit;
wherein the device for generating and issuing a parking ticket generates an identifier on the parking ticket;
opening of an entry blocking device which is embodied such that it communicates with the control unit and/or the device for generating and issuing a parking ticket, so that the device opens or can be opened once the parking ticket is issued;
accepting the parking ticket in a device for accepting a parking ticket which communicates with the control unit and detecting of the parking ticket via the device for accepting a parking ticket in order to release and/or realize the payment process; and
opening of an exit blocking device which is embodied such and is connected so as to communicate with the control unit and/or the device for accepting a parking ticket, so that it is opens up or can be opened once the identifier is detected,
wherein the control unit receives the identifier via the communication network;
wherein the control unit generates an exit permission signal in response to the transmission of the parking ticket identifier from a user to the control unit; and
wherein the control unit triggers and/or realizes the payment process as soon as the exit blocking device is or was confirmed.

### BRIEF DESCRIPTION OF THE DRAWINGS

Further details and advantages of the invention follow from the description below of exemplary embodiments in connection with the individual patent claims, which show in:

FIG. 1, the configuration of the system, using concrete tickets and entry and/or exit blocking devices;

FIG. 2, a schematic representation using virtual units; and

FIG. 3, a chronological flow chart from the start to the end of the parking process, including the payment.

The same or similar units in the Figures are given the same reference numbers.

In the Figures, the reference 10 relates to a control unit and 20 to a communication network which interact with each other. The control unit is connected via the communication network 20 to the additional units.

### DETAILED DESCRIPTION OF THE EXAMPLE EMBODIMENTS

In one specific aspect, at least one embodiment of the invention therefore relates to a system for managing a parking process of a vehicle in a parking zone subject to charge and a payment process for paying parking fees, comprising:
a control unit for controlling the parking process and the payment process, wherein the control unit communicates with a communication network;
a device for generating and issuing a parking ticket which communicates with the control unit, wherein the device for generating and issuing a parking ticket is embodied such that it generates an identifier on the parking ticket;
an entry blocking device, which is embodied so as to communicate with the control unit and/or the device for generating and issuing a parking ticket, such that it opens up or can open up once a parking ticket is issued;
a device for accepting a parking ticket which communicates with the control unit, wherein the device for accepting a parking ticket is designed to detect the identifier on the parking ticket in order to trigger and/or realize a payment process;
an exit blocking device, embodied so as to communicate with the control unit and/or the device for accepting a parking ticket, such that it opens up or can open up upon detecting the identifier,
   the control unit is embodied to receive the identifier via the communication network;
   the control unit is embodied to generate an exit permission signal in response to a user transmitting the identifier on the parking ticket to the control unit; and
   the control unit is embodied such that it triggers and/or realizes the payment process as soon as the exit blocking device is activated or was activated.

The realization of at least one embodiment of the invention is based on a parking zone with traditional gating.

As an alternative to the concrete “parking ticket” with identifier, an identification can also be provided which can be allocated differently, for example via the vehicle license number of the user's vehicle, via an on-board unit in the vehicle such as a navigation system, via a barcode or near-field communication (NFC), or a similar near-field frequency method, or an APP such as a smartphone APP.

Within the framework of at least one embodiment of the invention, the device for generating and issuing a parking ticket can also be provided in the form of a device for generating and issuing a different parking zone access and parking authorization. The entry into and/or exit from the parking zone need not be controlled via the parking ticket. Rather, the process can also be carried out via the aforementioned media, thus allowing the realization with the aid of a virtual gate.

The system and the corresponding method of at least one embodiment are used in gated parking zones or parking garages which can be accessed by vehicles, meaning motor vehicles, via entrance and/or exit gates and in which vehicles can be parked for a specific period of time in return for a fee. The user approaches the parking zone, requests a parking ticket at the entrance and, following the opening of the entrance blocking device, in particular a gate, can then drive into the parking zone or the parking garage. The parking ticket now contains a specific identification or ticket ID as well as an address which can be used later for the payment process. The address can be a speed dial number which can be contacted, e.g. via short-message-service (SMS), or which can be triggered by scanning in a QR (quick response) or a barcode.

A user wanting to pay via the system, for example, sends a SMS with the ticket ID, meaning the identifier affixed to the parking ticket, to a specified speed dial number. The user then receives a confirmation via SMS. As soon as the user receives this confirmation he/she can leave the gated parking zone or space with the vehicle at any time by inserting the ticket, as usual, into the device provided for it. The transmitted ticket ID or identifier only serves to detect the ticket. It does not contain information relating to the entry/exit point in time for the vehicle, on rates, or the length of the parking period. The amount for the parking fee is based on the respectively valid local parking fee structure for the parking garage operator. The amount owed upon exit is automatically debited following the exit. The fees are debited, for example, via mobile radio and/or from a prepaid account or the user's client account.

The parking period and the amount due are computed by the parking garage operator only after leaving the parking zone, for example the parking garage. The system for managing a vehicle parking process in a parking zone subject to charges and a payment process for paying the parking fees debits this amount from the respective user account and subsequently informs the user, e.g. via SMS.

If, owing to a temporary non-availability of the service, the payment of the parking fee via cell phone is not possible or if an exit signal cannot be generated, for example because an account has insufficient funds, the parking space user is still obligated to pay the fee. In that case, alternative payment options 25 are to be used, for example a cash register.

The control unit of one specific, alternative embodiment of the invention is embodied such that the identifier can be transmitted via short-message-service (SMS) from a mobile radio device of the user. Alternatively, the identifier can also be transmitted via an on-board unit (e.g. a navigation system), via a barcode or near-field communication (NFC) or a similar near-field frequency communication, or via an APP such as a smart phone APP.

According to one embodiment of the invention, the control unit is embodied such that the parking fee can be determined following the transmission of the identifier, preferably via SMS.

According to a different embodiment of the invention, the control unit is embodied such that it can monitor whether a user-specific account has sufficient funds for paying the parking fee, so that an exit permission is generated only if there are sufficient funds.

The control unit according to another embodiment of the invention is embodied such that it generates the exit permission signal only if it is confirmed that the parking fee can be debited or collected. That is to say, specific conditions must be met which make it possible to generate the exit permission signal and subsequent opening of the exit blocking device. A user-specific account can be a bank account, or an account for prepayment (account in credit), a credit card, a mobile wallet or a similar account.

According to one embodiment of the invention, the control unit is embodied such that the user receives a confirmation, preferably a SMS, indicating that the user can exit. With this information, the user is notified that payment is possible (e.g. that an account has sufficient funds) and that exiting is possible, meaning an opening of the exit blocking device, e.g. a gate in a parking garage, as soon as the ticket is inserted into the device for accepting the parking ticket. The confirmation can read as follows: your identifier was accepted by the system.

One embodiment according to the invention provides for the entry blocking device to be an entrance gate or barrier. According to a different embodiment, the exit blocking device is embodied as an exit gate or barrier. The blocking devices are advantageously also used to detect the parking event and for securing payment, wherein this can also be achieved with a virtual gating device, e.g. a combination of identifier detection and on-board unit and/or APP, for example a smartphone APP.

According to one embodiment of the invention, the control unit is designed at least in part as a separate device. As a separate device it can thus also be a component of the vehicle.

According to one embodiment of the invention, the control unit is designed to form a component of the device for generating and issuing a parking ticket and/or the device for accepting a parking ticket and/or the entry blocking device and/or the exit blocking device.

The control unit of another embodiment comprises a data storage device, preferably for storing rate information and/or information on the parking duration.

According to yet another embodiment of the invention, the control unit and/or the device for generating and issuing a parking ticket and/or the entry blocking device is/are designed to detect/record a moment for generating the parking ticket and/or a moment of entering, so that this/these can be stored in the control unit.

According to one embodiment of the invention, the moment of entering represents the point in time when the entry blocking device opens up.

According to a different embodiment of the invention, the control unit and/or the device for generating and issuing a parking ticket and/or the exit blocking device is/are designed so as to detect/record an exit moment on the parking ticket, so that it can be stored in the storage device of the control unit. The information required for computing the parking fee (actual rate, entering moment, exiting moment etc.) can thus be stored in the control unit, especially in one or in the storage device, so that the fee that is due can be computed following the transmission of the identifier on the parking ticket. The identifier itself does not contain any information to that effect.

According to one embodiment of the invention, the control unit and/or the system is/are designed such that the parking fee can be debited via or from the user-specific account.

According to a different aspect, at least one embodiment of the invention relates to the associated method for managing a vehicle parking process in a parking zone subject to charges and a payment process for paying the parking fees, with a control unit for controlling the parking process and the payment process, wherein the control unit is connected to a communication network, wherein the method comprises the following steps:
generating and issuing a parking ticket upon request from the user, with the aid of a device for issuing parking tickets which communicates with the control unit;
wherein the device for generating and issuing a parking ticket generates an identifier on the parking ticket;
opening of an entry blocking device which is embodied such that it communicates with the control unit and/or the device for generating and issuing a parking ticket, so that the device opens or can be opened once the parking ticket is issued;
accepting the parking ticket in a device for accepting a parking ticket which communicates with the control unit and detecting of the parking ticket via the device for accepting a parking ticket in order to release and/or realize the payment process; and
opening of an exit blocking device which is embodied such and is connected so as to communicate with the control unit and/or the device for accepting a parking ticket, so that it is opens up or can be opened once the identifier is detected,
wherein the control unit receives the identifier via the communication network;
wherein the control unit generates an exit permission signal in response to the transmission of the parking ticket identifier from a user to the control unit; and
wherein the control unit triggers and/or realizes the payment process as soon as the exit blocking device is or was confirmed.

With electrically operated vehicles, the aforementioned system can be used in a corresponding manner for the control, activation and computation of the electrical charge used in the accumulators of electric vehicles. It means that during the parking period the accumulators are charged at the same time and that the amount for the charging is debited by the above system according to the above-described method together with the parking fee.

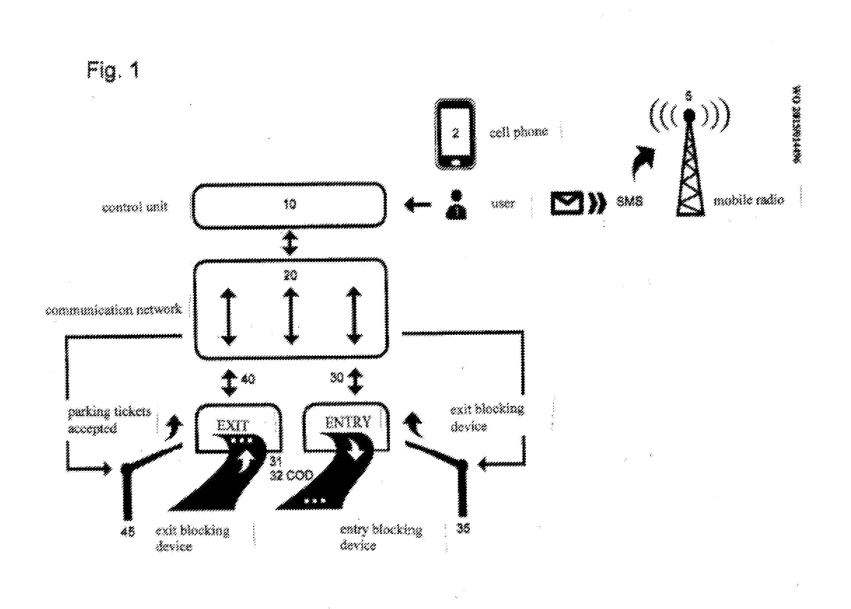

In FIG. 1 specifically, the control device 10 is connected to a user 1 with a cell phone 2 and the associated mobile radio network 5 and a central unit. A ticket issuing device 30 is provided which issues a ticket 31 with specific identifier 32. The identifier 32 serves to identify the user/vehicle and can also be realized in the form of a barcode.

The ticket issuing device 30, in turn, is connected to the entry blocking device 35. Parallel thereto, a ticket intake device 40 with an exit blocking device 45 is provided.

When entering the gated parking zone, the ticket 31 is issued upon request in the traditional manner. In the process, the identifier (code) is generated on the ticket. Via the identifier 31, the user-specific data of the user 1 are transmitted via the communication network 20 to the control unit 10. The entry blocking device 35 is then opened.

At the end of the parking process, the ticket 31 with identifier 32 is inserted into the ticket intake device 40. The ticket intake device 40, in turn, is connected to the exit blocking device 45. Once the ticket 31 with identifier 32 is inserted into the ticket intake device, the information including the time signal is transmitted via the communication network 20 to the control unit 10. The payment can be processed in the control unit 10 with the aid of the signal, and an exit permission signal is generated therein for the exit blocking device 45 (gate). The determined parking fee is transmitted by the control unit 10 via SMS or the like to the user 1.

In FIG. 1, the control device 10 with the following communication network 20 and further units are part of the central control for the parking zone, which establishes the connection via the mobile network to the external computer.

The control unit 10 can also be embodied as a separate component, installed in the user's own vehicle. Starting there, the exchange of information occurs in the same way via the communication network 20 with near-field method whenever the vehicle approaches the parking zone.

The latter offers the possibility of using an embodiment of the invention in non-gated parking zones, meaning in parking zones without a barrier. In place of the concrete demarcation, the exchange of identification signals is important in that case. The entry blocking device and the exit blocking device are then realized virtually.

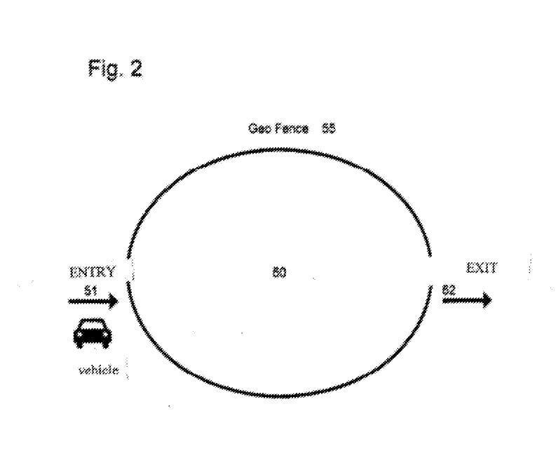

FIG. 2 illustrates this case. An area 50 that is designated as a parking zone is indicated in FIG. 2 which is enclosed by a virtual demarcation, a so-called “geo fence” (=GF) 55. In that case, an information exchange with corresponding identification occurs via the near-field method.

Once a vehicle enters an entry region 51 of the area 50 at the GF 55, the vehicle and/or the vehicle user is identified with the aid of the vehicle internal control unit 10.

For this exemplary embodiment, the vehicle license plate, an on-board unit with navigation system, a barcode or near-field communication (NFC) or a similar near-field frequency communication (blue tooth) or also an APP such as a smartphone APP can optionally be used for the identification.

When entering the delimited parking zone 50 at the entrance 51, the point in time of entering is recorded and is transmitted further together with the identifier for the user.

At the end of the parking process, the point of time for exiting is detected at the exit 52. The parking period is correlated with the fee list and a parking fee is determined. The amount of the parking fee can be debited from the user account in the same way via the mobile radio link.

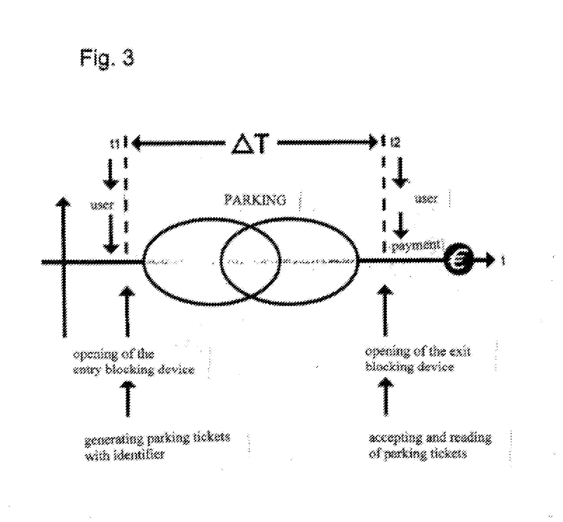

FIG. 3 illustrates the chronological sequence of steps for the system for managing the parking and payment processes. Plotted over time are the individual action moments: t1 designates the moment of entering, Delta t the parking period and t2 the moment of exiting. Essential is that the account is not debited until after the exit from the parking zone.

It is obvious that by identifying the vehicle with the respective user, the start of the parking period can be determined precisely. The same is true for the end of the parking period. Thus, when leaving the parking zone via the exit, the correct parking fee is debited in each case from the user account.

Further variants are possible. In particular, the various identification options make possible a problem-adapted use of the invention over a wide area.

### REFERENCE LIST

1 user
2 cell phone
3
4
5 mobile radio station
10 control unit
15 PC
20 communication network
25
26 electric vehicle
30 ticket issuing device
31 ticket
32 identifier
35 entry blocking device
40 ticket intake device
45 exit blocking device
50 parking zone with “geo fence”
51 entry
52 exit
55 “geo fence”
t time axis
t1 start of the parking period
t2 end of the parking period
Delta T parking period
70
75

1. A system for managing a parking process for a vehicle in a parking zone subject to charges and a payment process for paying parking fees, comprising:
at least one controller to control the parking process and the payment process, wherein the controller is connected to a communication network for transmitting signals;
first identifying device to identify at least one of a user of the vehicle and the vehicle at to communicate with the at least one control controller;
second identifying device to identify entry into the parking zone and to communicate with at least one of the at least one controller and the first identifying device;
determining device to determine a time of entry of the parking zone by the vehicle and to communicate with the at least one controller, wherein the determining device is designed to identify the entry time for at least one of triggering and realizing the payment process; and
communication device, embodied to communicate with at least one of the controller, the first identifying device, the second identifying device and the determining device, to release an exit process, wherein
the at least one controller is embodied to receive and process identification signals via the communication network;
the at least one controller is designed to generate an exit permission signal in response to the transmission of the identification signals from a user to the at least one controller;
and the at least one controller is embodied to at least one of trigger and realize the payment process as soon as the vehicle exits the parking zone.

2. The system of claim 1, wherein
the first identifying device serves to identify a device, to generate and issue a parking ticket, configured to communicate with the at least one controller;
the second identifying device and the device to generate and issue a parking ticket are embodied to affix an identifier to the parking ticket;
the determining device includes an entry blocking device, embodied to communicates with at least one of the at least one controller and/or the device to generate and issue the parking ticket, and embodied to opens up or be opened when a parking ticket is issued; and
the communication device additionally includes
a device to accept the parking ticket, configured to communicate with the at least one controller, wherein the device to accept the parking ticket is embodied to detect the identifier on the parking ticket to at least one of trigger and realize the payment process,
and
an exit blocking device, configured to communicate with at least one of the at least one controller and the device to accept the parking ticket, to opens up or be opened upon detecting the identifier.

3. The system of claim 1, wherein telecommunication methods are used for identification via an on-board unit, via a barcode or near-field communication (NFC), or via an APP.

4. The system of claim 1, wherein
the first identifying device is embodied as a device to generate and issue a specific parking zone access and event authorization.

5. The system of claim 1, wherein the at least one controller is embodied such that the identifier is transmittable via short-message service (SMS) from a mobile radio device of the user.

6. The system of claim 1, wherein the at least one controller is embodied such that following the transmission of the identifier, the parking fee is determinable.

7. The system of claim 1, wherein the at least one controller is embodied to monitor whether a user-specific account has sufficient funds to cover the parking fee, and to generate the exit permission only if the coverage is confirmed.

8. The system of claim 1, wherein the at least one controller is embodied to generate the exit permission signal only once it is confirmed that the parking fee can be debited or collected.

9. The system of claim 1, wherein the at least one controller is embodied to enable the user to receives a confirmation indicating that an exiting is possible.

10. The system of claim 2, wherein the entry blocking device is embodied as an entry gate.

11. The system of claim 2, wherein the exit blocking device is embodied as an exit gate.

12. The system of claim 1, wherein the at least one controller is embodied at least partially as a separate device.

13. The system of claim 2, wherein the at least one controller forms a component of at least one of the device to generate and issue a parking ticket, the device to accept a parking ticket, the entry blocking device and the exit blocking device.

14. The system of claim 1, wherein the at least one controller comprises a storage device to store data.

15. The system of claim 1, wherein at least one of the at least one controller, the device to generate and issue a parking ticket, and the entry blocking device is embodied to at least one of detect and record at least one of a moment in which the parking ticket is generated and a moment when the vehicle enters, to store the at least one moment in the at least one controller.

16. The system of claim 15, wherein the entering moment represents the moment in which the entry blocking device opens up.

17. The system according of claim 2, wherein at least one of the at least one controller, the device to accept parking tickets, and the exit blocking device is embodied to detect an exit moment on the parking ticket, and to store the at least one moment in the storage device of the at least one controller.

18. The system of claim 1, wherein at least one of the at least one controller, and the system is embodied to debit the parking fee via a user-specific account.

19. A method for managing a parking process of a vehicle in a parking zone subject to charge and a payment process for paying parking fees, including at least one controller to control the parking process and the payment process, the at least one controller being linked to a communication network,
the method comprising:
generating and issuing an information upon request from a user;
generating and issuing a user-specific identifier;
releasing a user-specific access; and
accepting and reading the information and the user-specific identification with identifier, the accepting and reading including
receiving, at the at least one controller and via the communication network, the identifier;
generating, via the at least one controller, an exit permission signal in response to a user transmitting the identifier to the at least one controller,
at least one of triggering and realizing, via the at least one controller, the payment process, upon generation of an exit permission signal.

20. The method of claim 19, wherein a parking zone with gating is present and wherein parking tickets are used, the method further comprising:
identifying the parking ticket in a device to accept a parking ticket and configured to communicates with the at least one controller;
detecting the identification on the parking ticket with the aid of the device to accept a parking tickets, to at least one of trigger and realize a payment process;
opening an exit blocking device, embodied to communicates with at least one of the at least one controller and the device to accept a parking ticket, the exit blocking device being configured to opens up be opened upon detecting the identifier;
wherein the at least one controller is configured to receive the identification on the parking ticket via the communication network,
generates an exit permission signal in response to a user transmitting the identifier on the parking ticket to the at least one controller, and at least one of
trigger and realize the payment process as soon as a confirmation is received from the exit blocking device.

21. The method of claim 19, wherein
at least one of the signals and data are transmitted via SMS or mobile radio or bluetooth.

22. The system of claim 3, wherein the on-board unit is a navigation system, or the APP is a smartphone APP.

23. The system of claim 5, wherein the at least one controller is embodied such that following the SMS transmission of the identifier, the parking fee is determinable.

24. The system of claim 9, wherein the confirmation is sent via an SMS transmission.

25. The system of claim 14, wherein the data includes at least one of rate information and parking period information.

26. The method of claim 20, wherein at least one of the signals and data are transmitted via SMS or mobile radio or bluetooth.
